(19) United States
(12) Patent Application Publication
(10) Pub. No.: US 2011/0049061 A1
(43) Pub. Date: Mar. 3, 2011

(54) METHOD FOR TREATING ODOR IN WASTEWATER

(76) Inventors: Elbert Alden Hale, Orlando, FL (US); James Paul Harshman, Bradenton, FL (US)

(21) Appl. No.: 12/870,968

(22) Filed: Aug. 30, 2010

Related U.S. Application Data
(60) Provisional application No. 61/237,800, filed on Aug. 28, 2009.

(51) Int. Cl. C02F 1/68; C02F 1/72

(52) U.S. Cl. 210/752; 210/96.1; 210/759

(57) ABSTRACT

Disclosed herein is method of treating wastewater to remove odorous sulfide compounds. The method includes measuring a concentration of a dissolved sulfide compound contacting the wastewater with an enhanced hydrogen peroxide solution to produce a molecular ratio of not more than four to one of hydrogen peroxide to the dissolved sulfide compound in the wastewater, and maintaining the wastewater under conditions sufficient to lessen a concentration of the dissolved sulfide compound in the wastewater to an acceptable level after an enhanced residence time of the hydrogen peroxide in the wastewater.

### RELATED APPLICATIONS

This application claims priority under 35 U.S.C. §119(e) to U.S. Provisional Application Ser. No. 61/237,800. titled “USE OF STABILIZED HYDROGEN PEROXIDE FOR THE TREATMENT OF ODOR IN SEWAGE,” filed on Aug. 28, 2009 which is herein incorporated by reference in its entirety.

### BACKGROUND OF INVENTION

1. Field of Invention

Aspects and embodiments of the present invention are directed to wastewater treatment and, more specifically, to the treatment of wastewater with an enhanced hydrogen peroxide solution to remove odor causing compounds.

2. Discussion of Related Art

Sewage systems typically include conduits that collect and direct sewage and other waste streams, such as industrial effluents, to a treatment facility. Such systems typically include various pumping facilities, such as lift stations, that facilitate the transfer of wastewater to such treatment facilities. During transit odorous species are often generated. Such odorous species may be objectionable when released or discharged. Untreated sewage may generate multiple odor-causing compounds. One of the most prevalent and most distinctive compounds formed is hydrogen sulfide (H₂S).

Hydrogen sulfide may be formed in wastewater streams by the conversion of sulfates to sulfides by sulfide reducing bacteria (SRBs) under anaerobic conditions. Hydrogen sulfide is dissolvable in water (up to about 0.4 g/100 ml at 20 degrees Celsius and 1 atmospheric pressure). In water, hydrogen sulfide exists in equilibrium with the bisulfide ion HS⁻ and the sulfide ion S²⁻, Unlike sulfide and bisulfide, hydrogen sulfide is volatile, with a vapor pressure of about 1.56×10⁴ mm Hg (2.1 MPa) at 25 degrees Celsius, and may emerge from aqueous solution to form gaseous hydrogen sulfide. The presence of hydrogen sulfide in sewer systems is undesirable due to its offensive odor, toxicity, and corrosivity.

Gaseous hydrogen sulfide exhibits a characteristic unpleasant odor suggestive of rotten eggs. Humans can detect this odor at hydrogen sulfide concentrations as low as four parts per billon (ppb). Hydrogen sulfide is considered toxic. Extended exposure to a few hundred ppm can cause unconsciousness and death. Accordingly, the presence of hydrogen sulfide in sewer systems is found objectionable to people who may come into contact with the gaseous effluent from such sewer systems.

Hydrogen sulfide may not only be harmful to humans or other animals, but may also be harmful to a sewer system in which it is present. Gaseous hydrogen sulfide present in a sewer system may dissolve into water which may have condensed on walls or other surfaces within the sewer system. Once dissolved in the water, sulfuric acid may be formed by oxidation of the dissolved hydrogen sulfide. The sulfuric acid so formed can cause severe corrosion to metal and concrete structures in or around the sewer system.

Hydrogen sulfide also supports the growth of organisms such as thiothrix and beggiatoa. These are filamentous organisms which are associated with bulking problems in activated sludge treatment systems.

Hydrogen sulfide may be removed from wastewater by methods including oxidation with compounds such as potassium permanganate, chlorine, sodium chlorite, and iron(III) salts.

### SUMMARY OF INVENTION

In accordance with an embodiment of the present invention, there is provided a method of treating wastewater. The method comprises measuring a concentration of a reduced sulfur compound in the wastewater, the reduced sulfur compound comprising a dissolved sulfide, contacting the wastewater with an amount of an enhanced hydrogen peroxide solution producing a molecular ratio of not more than four to one of hydrogen peroxide to the dissolved sulfide in the wastewater, and maintaining the wastewater under conditions sufficient to lessen a concentration of the dissolved sulfide in the wastewater to less than one milligram per liter after an enhanced residence time of the hydrogen peroxide in the wastewater.

In accordance with some aspects, the method further comprises flowing the wastewater through a conduit. The method may further comprise providing a control system configured to measure at least one of a concentration of the reduced sulfur compound dissolved in the wastewater and a concentration of a gaseous form of the reduced sulfur compound present in air above the wastewater, and to adjust a rate of addition of the enhanced hydrogen peroxide solution to the wastewater based at least in part on the measured concentration. The concentration of the at least one of the reduced sulfur compound dissolved in the wastewater and the gaseous form of the reduced sulfur compound present in air above the wastewater may be measured upstream of a point in the conduit at which the wastewater is contacted with the enhanced hydrogen peroxide. The concentration of the at least one of the reduced sulfur compound dissolved in the wastewater and the gaseous form of the reduced sulfur compound present in air above the wastewater may be measured downstream of a point in the conduit at which the wastewater is contacted with the enhanced hydrogen peroxide. The concentration of the at least one of the reduced sulfur compound dissolved in the wastewater and the gaseous form of the reduced sulfur compound present in air above the wastewater may be measured at a point in the conduit to which the wastewater has flowed after an enhanced residence time greater than about four hours.

In accordance with some aspects, the control system is configured to measure a pH of the wastewater and to add a quantity of pH adjustment agent to the wastewater in response to the measured pH being outside a defined range. In accordance with some aspects, the control system is configured to add a quantity of catalyst to the wastewater in response to the measured concentration being outside a defined range.

In accordance with some aspects, the reduced sulfur compound is at least one of hydrogen sulfide, carbon disulfide, dimethyl sulfide, dimethyl disulfide, dimethyl trisulfide, a methyl mercaptan, an ethyl mercaptan, an allyl mercaptan, a propyl mercaptan, a crotyl mercaptan, a benzyl mercaptan, thiophenol, sulfur dioxide, and carbon oxysulfide.

In accordance with another embodiment of the present invention there is provided a method of treating wastewater. The method comprises measuring a concentration of a reduced sulfur compound in the wastewater, contacting the wastewater with an amount of an enhanced hydrogen peroxide solution producing a molecular ratio of not more than four to one of hydrogen peroxide to the dissolved sulfide in the wastewater, and maintaining the wastewater under conditions sufficient to provide at least 1 ppm residual active hydrogen peroxide in the wastewater after an enhanced residence time of the hydrogen peroxide in the wastewater.

In accordance with some aspects, the method further comprises providing a control system configured to measure a concentration of hydrogen peroxide in the wastewater, and to adjust a rate of addition of the enhanced hydrogen peroxide solution to the wastewater based on the measured concentration.

In accordance with some aspects, the concentration of the hydrogen peroxide in the wastewater is measured at a point in a conduit to which the wastewater has flowed after an enhanced residence time greater than about four hours.

In accordance with some aspects, the control system is further configured to measure a concentration of gaseous hydrogen sulfide and to adjust a quantity of pH adjustment agent added to the wastewater in response to the measured concentration of hydrogen sulfide and the measured concentration of gaseous hydrogen sulfide.

In accordance with some aspects, the control system is configured to add a quantity of catalyst to the wastewater in response to the measured concentration being outside a defined range.

In accordance with another embodiment of the present invention, there is provided a method of facilitating the removal of odorous compounds from wastewater. The method comprises providing a quantity of an enhanced hydrogen peroxide solution comprising about five weight percent of a nitrate based stabilization agent, between about 40 weight percent and about 51 weight percent hydrogen peroxide, and between about 44 weight percent and about 55 weight percent water and providing instructions for treating the wastewater with the enhanced hydrogen peroxide solution to result in a desired concentration of a dissolved sulfide in the wastewater after a desired enhanced residence time of the hydrogen peroxide solution in the wastewater.

The method may further comprise providing instructions for modifying a rate of addition of the enhanced hydrogen peroxide to the wastewater based on a measurement of a dissolved sulfide in the wastewater.

The method may further comprise providing instructions for modifying a rate of addition of the enhanced hydrogen peroxide to the wastewater based on a measurement of a gaseous sulfide compound produced from the wastewater.

The method may further comprise providing instructions for modifying a rate of addition of the enhanced hydrogen peroxide to the wastewater based on a measurement of a residual amount of hydrogen peroxide remaining in the wastewater at a defined time after the treatment of the wastewater with the enhanced hydrogen peroxide.

The method may further comprise providing instructions for modifying a rate of addition of a pH adjustment agent to the wastewater based on a comparison of a concentration of dissolved sulfide in the wastewater with a concentration of a gaseous sulfide compound present above the wastewater at a defined time after the treatment of the wastewater with the enhanced hydrogen peroxide.

In accordance with another embodiment of the present invention, there is provided a system for treating wastewater flowing through a conduit. The system comprises a source of a hydrogen peroxide solution comprising about five weight percent of a nitrate based stabilization agent, between about 40 weight percent and about 51 weight percent hydrogen peroxide, and between about 44 weight percent and about 55 weight percent water, a dosing system configured to inject the hydrogen peroxide solution into the conduit, a first sensor configured to measure a concentration of at least one of sulfide dissolved in the wastewater and gaseous hydrogen sulfide above a surface of the wastewater in the conduit upstream of the dosing system, and a controller configured to receive a signal from the first sensor and adjust a rate of addition of the hydrogen peroxide solution into the conduit based at least in part on the signal from the first sensor.

The system may further comprise a second sensor configured to measure a concentration of at least one of sulfide dissolved in the wastewater and gaseous hydrogen sulfide above a surface of the wastewater in the conduit downstream of the dosing system and to provide the controller with a signal indicative of the measured concentration, wherein the controller is further configured to adjust a rate of addition of the hydrogen peroxide solution into the conduit based at least in part on the signal from the second sensor.

The system may further comprise a second sensor configured to measure a concentration of hydrogen peroxide in the wastewater downstream of the dosing system and to provide the controller with a signal indicative of the measured concentration, wherein the controller is further configured to adjust a rate of addition of the hydrogen peroxide solution into the conduit based at least in part on the signal from the second sensor.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a general-purpose computer system upon which various embodiments of the invention may be implemented;

FIG. 2 is a block diagram of a computer data storage system with which various embodiments of the invention may be practiced;

FIG. 3 is a block diagram of a portion of a wastewater pumping system described in conjunction with a prophetic example; and

FIG. 4 is a block diagram of a method of wastewater treatment in accordance with an embodiment of the present invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

It is generally desirable to remove hydrogen sulfide from wastewater to reduce the potential for the wastewater to emit objectionable odors. An acceptable level of hydrogen sulfide present in a wastewater stream varies by jurisdiction and by municipality. For example, in one municipality in California, an objective for wastewater odor control is to mitigate gaseous hydrogen sulfide to less than 30 parts per billion (ppb). This goal is met primarily by reducing dissolved sulfides in the wastewater to less than about 0.1 mg/L, then passing escaping air through an adsorbent.

It has been discovered that sulfides in wastewater may be oxidized by hydrogen peroxide resulting in the formation of compounds such as sulfates or even elemental sulfur. Sulfates and elemental sulfur do not exhibit the odor or the volatility of hydrogen sulfide. Hydrogen peroxide may react with sulfides under acid, neutral, and alkaline conditions. The reaction may be catalyzed by the presence of iron, copper, and manganese containing compounds to favor sulfate formation, or nickel or vanadium containing compounds which favor elemental sulfur formation.

Under acidic or neutral conditions the reaction of hydrogen sulfide with hydrogen peroxide produces sulfur and water:

H₂S+H₂O₂→S+2H₂O

Ideally, under conditions of acidic/neutral pH hydrogen peroxide reacts with hydrogen sulfide at a stoichiometric ratio of 1:1. Because hydrogen peroxide is a strong oxidizer, it may react with materials other than hydrogen sulfide in wastewater. It may thus he desirable to, in certain instances, add more than the stoichiometric amount of hydrogen peroxide to wastewater to react with a given amount of hydrogen sulfide contained in the wastewater to achieve a desired amount of removal of hydrogen sulfide.

In alkaline solutions (pH>8), the dominant reaction between hydrogen sulfide and hydrogen peroxide is:

H₂S+H₂O₂→SO₄²⁻+4H₂O+2H⁺

In some implementations oxygen may be provided by, for example, aeration of the wastewater, which may reduce the amount of hydrogen peroxide required to react with a given amount of hydrogen sulfide.

Hydrogen peroxide is a metastable molecule, which breaks down to form water and oxygen. Hydrogen peroxide decomposition may be catalyzed by trace levels of contaminants (for example, transition metals such as copper, manganese, or iron). Most commercial grades of hydrogen peroxide contain chelants and sequestrants which stabilize the hydrogen peroxide solution, reducing the rate of decomposition of the hydrogen peroxide under normal storage and handling conditions.

The types of stabilizers used in stabilized hydrogen peroxide vary between producers and product grades. Common stabilizers include, for example colloidal stannate, sodium pyrophosphate, organophosphonates, and colloidal silicate.

Hydrogen peroxide solutions are generally more stable at low pH. Thus, some producers may add acids such as phosphoric acid to lower the pH of a hydrogen peroxide solution.

Commonly available grades of stabilized (or unstabilized) hydrogen peroxide (alternatively referred to herein as “standard hydrogen peroxide”) may be used with some success to treat wastewater streams by reacting with sulfides in the wastewater. If standard hydrogen peroxide is dosed (added or injected) into a wastewater stream in a sewer line, the standard hydrogen peroxide may convert sulfides in the wastewater to sulfates. As the wastewater continues to flow downstream in the sewer line, however, additional sulfides may be produced from anaerobic decomposition of compounds in the wastewater. The standard hydrogen peroxide reacts not only with sulfides, but also with other reduced compounds and begins to catalytically decompose immediately upon contact with the wastewater. After a period of time, no active (not broken down into water and oxygen) hydrogen peroxide would remain to remove any sulfides formed downstream.

Overdosing wastewater by adding more than the stoichiometric amount of hydrogen peroxide needed to react with a given amount of sulfides contained in wastewater may be performed to provide enough hydrogen peroxide such that at least some residual unreacted hydrogen peroxide remains in the wastewater downstream of the injection point. This residual unreacted hydrogen peroxide may react with to sulfides formed in the wastewater downstream of the hydrogen peroxide injection point. Standard hydrogen peroxide breaks down quickly in wastewater, so a large amount of overdosing (and associated chemical cost) may be required to obtain residual unreacted hydrogen peroxide in the wastewater for any appreciable amount of time. For example, overdosing wastewater with standard hydrogen peroxide at about four times the stoichiometric ratio of hydrogen peroxide to hydrogen sulfide in wastewater typically results in residual levels of hydrogen peroxide remaining in the wastewater for between about one-half to about three hours, depending on factors such as wastewater flow rate and turbulence, temperature, and biochemical oxygen demand of components of the wastewater.

To address these problems, an enhanced hydrogen peroxide solution (alternatively referred to herein as “enhanced hydrogen peroxide”) has been developed which has a greater selectivity to sulfides than other common oxidizable components of wastewater such as alcohols or organic compounds than standard hydrogen peroxide solutions, and which subsequently has a greater stability in wastewater than standard hydrogen peroxide solutions. The hydrogen peroxide in the enhanced hydrogen peroxide solution does not break down into water and oxygen when exposed to contaminants typical of wastewater streams as quickly as hydrogen peroxide in a standard hydrogen peroxide solution. Thus, the residual effect of the enhanced hydrogen peroxide may persist longer in a sewer that standard hydrogen peroxide. For example, the enhanced hydrogen peroxide may remain active in wastewater for an enhanced residence time of from 110% to 200% or more as long as standard hydrogen peroxide. As used herein, the term “enhanced residence time” denotes a time that hydrogen peroxide derived from an enhanced hydrogen peroxide solution may remain active in wastewater which is greater than a time for which a comparable amount of hydrogen peroxide derived from a standard hydrogen peroxide may remain active in the wastewater under similar conditions.

One specific enhanced hydrogen peroxide includes a nitrate based stabilization agent. This enhanced hydrogen peroxide is sold under the product name Peroxide XL, available from FMC Corp., Bayport, Tex., USA. The nitrate based stabilization agent may be present in Peroxide XL at level of about 5 percent by weight. Hydrogen peroxide may be present in Peroxide XL at a level of between about 40 percent by weight and about 51 percent by weight and water may be present in the enhanced hydrogen peroxide solution at a level of between about 44 percent by weight and about 55 percent by weight. Peroxide XL may have a pH of less than about 3. Peroxide XL may have a specific gravity of about 1.26 at 20 degrees Celsius.

Aspects and embodiments of the present invention are directed to systems and methods of treating wastewater with enhanced hydrogen peroxide. In various embodiments, enhanced hydrogen peroxide may be added to a wastewater stream in a sewer system or other wastewater conduit. In some embodiments, enhanced hydrogen peroxide may be added to a wastewater in a treatment vessel or a pool. In some embodiments, enhanced hydrogen peroxide may be added to a wastewater stream in a sewer line. In some embodiments, enhanced hydrogen peroxide may be added to a wastewater stream upstream of a wastewater treatment plant. In some embodiments, enhanced hydrogen peroxide may be added to a wastewater stream upstream, downstream, and/or at a pumping station. In some embodiments, enhanced hydrogen peroxide may be added to a wastewater stream upstream, downstream, and/or at a lift station. In some embodiments, enhanced hydrogen peroxide may be added to a wastewater stream upstream, downstream, and/or at a surge tank.

Hydrogen peroxide in the enhanced hydrogen peroxide solution may react with hydrogen sulfide in the wastewater and oxidize the hydrogen sulfide. The hydrogen peroxide may also react with one or more other odorous reduced sulfur compounds present in the wastewater. These reduced sulfur compounds may include, for example, any one or more of carbon disulfide, dimethyl sulfide, dimethyl disulfide, dimethyl trisulfide, methyl mercaptans, ethyl mercaptans, allyl mercaptans, propyl mercaptans, crotyl mercaptans, benzyl mercaptans, thiophenol sulfur dioxide, and carbon oxysulfide. Aspects and embodiments of the present invention are described herein with reference to the removal of hydrogen sulfide from wastewater, but are equally applicable to the removal of one or more other reduced sulfur compounds from wastewater.

Enhanced hydrogen peroxide may remain effective in removing hydrogen sulfide from wastewater after an enhanced residence time of the enhanced hydrogen peroxide in the wastewater of about four hours or greater. In some embodiments, the enhanced hydrogen peroxide may remain effective in removing hydrogen sulfide from wastewater after an enhanced residence time of the enhanced hydrogen peroxide in the wastewater of between about five hours and about seven hours. In some embodiments, the enhanced hydrogen peroxide may remain effective in removing hydrogen sulfide from wastewater after an enhanced residence time of the enhanced hydrogen peroxide in the wastewater of up to about nine hours. This compares to standard hydrogen peroxide which breaks down and becomes ineffective at removing hydrogen sulfide from wastewater within a much shorter time frame, e.g., within minutes of coming into contact with the wastewater, or when overdosed at about four times the stoichiometric ratio of hydrogen peroxide to hydrogen sulfide, within about three hours.

In some embodiments of the present invention, in addition to enhanced hydrogen peroxide, one ore more catalysts are added to the wastewater to enhance the reaction of the added hydrogen peroxide with hydrogen sulfide. These catalysts may include compounds such as cations of iron as well as several other metals. In some embodiments, in addition to enhanced hydrogen peroxide, one or more pH adjustment agents may be added to the wastewater. The pH adjustment agent(s) may increase the time for which hydrogen peroxide may remain active in the wastewater. The pH adjustment agent may result in volatile sulfur compounds being maintained as, or converted to, soluble sulfate compounds in the wastewater. The pH adjustment agent(s) may include acids, for example nitric acid or phosphoric acid, or may include caustics, for example, sodium hydroxide. One or both of a catalyst and a pH adjustment agent may be added to a wastewater stream upstream, downstream, and/or at a same location as enhanced hydrogen peroxide is added to the wastewater.

The increased residence time for which hydrogen peroxide from the enhanced hydrogen peroxide solution may remain active in wastewater for the removal of hydrogen sulfide, as compared to standard hydrogen peroxide, provides for numerous advantages. For example, with the enhanced hydrogen peroxide, active hydrogen peroxide may remain in the wastewater at residence times of up to about nine hours and continue to be effective for removing any newly formed hydrogen sulfide over this time period. This additional time period may be sufficient for the wastewater to have travelled away from locations where the odor produced from hydrogen sulfide in the wastewater would be noticed or found objectionable. Use of the enhanced hydrogen peroxide instead of, or in addition to standard hydrogen peroxide may reduce the number of points along a wastewater sewer line at which the wastewater would require dosing with hydrogen peroxide to maintain active hydrogen peroxide in the wastewater for the removal of sulfides. This may reduce the capital and maintenance costs of a wastewater treatment system or sewer system. Further, a lesser quantity of enhanced hydrogen peroxide may be added to wastewater to provide the same benefits with regard to removing and/or preventing the formation of hydrogen sulfide in wastewater over time as a greater quantity of standard hydrogen peroxide. This may result in decreased chemical costs for the operator of a wastewater treatment or sewer system.

In some embodiments enhanced hydrogen peroxide is continuously added to a wastewater stream at an injection point. The amount of enhanced hydrogen peroxide desired to be dosed into a wastewater stream may depend on factors such as the volume of wastewater flow, the concentration of sulfides and/or substances which could form hydrogen sulfide in the wastewater, a desired level of sulfides in the wastewater at different amounts of time or at different distances downstream after treatment with the enhanced hydrogen peroxide, and the amount of time desired that active hydrogen peroxide remain present in the wastewater after dosing.

The factors which may affect the amount of enhanced hydrogen peroxide desired to be dosed into a wastewater stream vary by time of day or time of year. For example, wastewater production may be expected to be lesser during the late night hours than during the morning or daytime hours. Thus, less enhanced hydrogen peroxide may be desired to be added to a wastewater stream during the late night hours than during the morning or daytime hours. In some communities, including vacation communities such as Cape Cod, Mass. or parts of Florida, the population may vary with the time of year, rising significantly during the summer versus the winter. Accordingly, more wastewater may be produced during summer months than during winter months, and a greater amount of enhanced hydrogen peroxide may be desired to be dosed into the wastewater during the summer to account for the increased volume of wastewater. In other vacation areas, such as Vale, Colo., the population may increase during the winter months and more wastewater may be produced during winter months than during summer months, and a greater amount of enhanced hydrogen peroxide may be desired to be dosed into the wastewater during the winter to account for the increased volume of wastewater. In some communities, the amount of rainfall may vary by season, thus altering the concentration of components of wastewater flowing through a sewer. Less enhanced hydrogen peroxide may be desired to be added to a wastewater stream which has been diluted with rainwater than one which has not been diluted. The amount of gaseous hydrogen sulfide that volatilizes from hydrogen sulfide dissolved in wastewater generally increases with temperature. A higher concentration of hydrogen sulfide in a wastewater stream may thus be acceptable during colder parts of the year than warmer, and less enhanced hydrogen peroxide may be used during colder parts of the year than during warmer parts of the year to achieve a lower desired level of dissolved hydrogen sulfide.

In some embodiments, the amount of enhanced hydrogen peroxide added to a wastewater stream may be controlled to account for the variation in the factors described above. This may be desirable so as not to use more enhanced hydrogen peroxide than necessary to achieve a desired level of hydrogen sulfide or a desired reduction in hydrogen sulfide in or above a wastewater stream so that chemical costs may be controlled. In some embodiments, a controller, such as a Versadose™ controller, available from Siemens Water Technologies Corp., Warrendale, Pa., LISA, may be utilized to vary the flow of enhanced hydrogen peroxide dosed into a wastewater stream by time of day.

In some embodiments, the amount of enhanced hydrogen peroxide dosed into a wastewater stream may be controlled by feedback from one or more sensors capable of detecting a level of hydrogen sulfide dissolved in a wastewater stream and/or in gaseous form above a wastewater stream. Such sensors may include, for example, an OdaLog™ hydrogen sulfide sensor, or a VaporLink™ hydrogen sulfide sensor, both available from Siemens Water Technologies Corp. The sensor (or sensors) may provide feedback regarding a level of atmospheric hydrogen sulfide in or near a manhole or pump station handling wastewater upstream or downstream of an enhanced hydrogen peroxide dosing point. A dosing flow controller at the dosing point may adjust the amount of enhanced hydrogen peroxide added to the wastewater at the dosing point to maintain a desired level of sulfide dissolved in the wastewater and/or hydrogen sulfide in gaseous form above the wastewater at one or more points downstream of the dosing point as determined by the sensor or sensors.

A control system including hydrogen sulfide sensors and dosing control systems for the addition of chemical treatments into a wastewater sewer system which may be utilized in conjunction with embodiments of the present invention is described in co-pending application Ser. No. 11/542,649 “DOSING CONTROL SYSTEM AND METHOD,” filed Oct. 2, 2006, which is herby incorporated by reference in its entirety for all purposes.

Alternatively or in addition to measuring a level or concentration of either gaseous hydrogen sulfide or dissolved sulfides, a level of hydrogen peroxide in a wastewater stream at a location of interest upstream and/or downstream from an enhanced hydrogen peroxide dosing site could be monitored. If there was no residual enhanced hydrogen peroxide in the wastewater at a location of interest downstream of an enhanced hydrogen peroxide dosing point, this would be indicative of possibly too low a dose being injected in the wastewater to provide for sufficient hydrogen peroxide to remain in the wastewater at the location of interest to provide for hydrogen sulfide destruction. The rate of enhanced hydrogen peroxide addition at the dosing location could be adjusted until a desired concentration of residual hydrogen peroxide in the wastewater at the location of interest was observed.

Likewise, the oxidation reduction potential (ORP) of the wastewater could be measured. Wastewater containing sulfides is septic and is generally expected to have a negative ORP, and wastewater with a hydrogen peroxide residual would generally be expected to have a positive ORP. Thus the feed rate of enhanced hydrogen peroxide into a wastewater stream could be increased if the ORP was negative, or decreased if the ORP downstream of an enhanced hydrogen peroxide dosing point was positive. Systems and methods for reducing odors utilizing oxidation-reduction potential to characterize the quality of water or wastewater and to control addition of a species thereto that reduces or inhibits biological sulfide generation are described in U.S. Pat. No. 7,326,340, “SYSTEM FOR CONTROLLING SULFIDE GENERATION,” issued Feb. 5, 2008, which is hereby incorporated by reference in its entirety for all purposes.

In some embodiments, the quantity of enhanced hydrogen peroxide dosed may be greater than is necessary to provide a stoichiometric 1:1 molecular ratio of hydrogen peroxide to hydrogen sulfide in the wastewater. This overdosing may provide additional hydrogen peroxide to react with other components of the wastewater stream having a high biochemical oxygen demand, such as alcohols or organic components. The overdosing may alternatively or additionally provide for an increased residence time of active hydrogen peroxide in the wastewater than would be achieved by providing a 1:1 stoichiometric hydrogen peroxide to hydrogen sulfide dose. For example, in some embodiments a quantity of hydrogen sulfide in a wastewater stream may be measured (or calculated from a measurement of gaseous hydrogen sulfide above the wastewater), and an amount of hydrogen peroxide may be determined which will be sufficient to produce a desired level of hydrogen sulfide, for example less than one mg/L in wastewater after a residence time of, for example, four hours or more. In some embodiments, the residence time at or after which the concentration of hydrogen sulfide in the wastewater may be measured may be greater or less than four hours, for example, from about five to seven hours, or up to nine hours. The desired level of hydrogen sulfide present in the wastewater at the measurement point may also vary, for example from about 0 mg/L to about five mg/L or more. In some embodiments, the desired level of hydrogen sulfide present in the wastewater at the measurement point may be such that it does not result in the formation of an objectionable level of gaseous hydrogen sulfide above the wastewater.

In some embodiments the enhanced hydrogen peroxide may be dosed at a volume or rate to produce a 2:1 molecular ratio of hydrogen peroxide to hydrogen sulfide in the wastewater. In other embodiments, this ratio may be 3:1, 4:1, 5:1, or any ratio in between. In further embodiments, this ratio may be less than 2:1, for example about 1:1 or even less. If one or more reduced sulfur compounds other than, or in addition to, hydrogen sulfide are desired to removed from the wastewater, the amount of enhanced hydrogen peroxide dosed may be determined based at least in part upon a measurement of a concentration of the one or more reduced sulfur compounds other than hydrogen sulfide.

It is generally considered in the wastewater treatment industry to be economically unviable to overdose a wastewater stream to remove hydrogen sulfide by dosing wastewater with a standard hydrogen peroxide solution to provide a ratio of hydrogen peroxide to hydrogen sulfide present in the wastewater of greater than about 4:1. Even at this high a ratio of hydrogen peroxide to hydrogen sulfide, hydrogen peroxide from a standard hydrogen peroxide solution only remains viable in wastewater for at most about three hours. Enhanced hydrogen peroxide will, under similar conditions, provide hydrogen peroxide which remains viable in wastewater for greater than three hours at a significantly lower overdose ratio. At an overdose ratio of 4:1 hydrogen peroxide from an enhanced hydrogen peroxide solution may remain viable for up to about nine hours in wastewater which would render hydrogen peroxide from a standard hydrogen peroxide solution unviable within three hours.

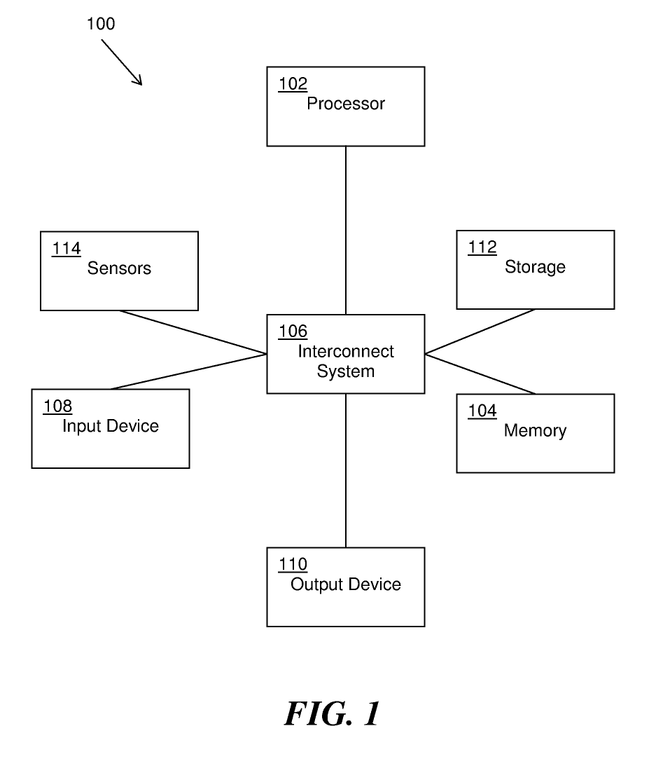

The monitoring of the hydrogen sulfide level in a wastewater stream and the adjustment of a dosage level of enhanced hydrogen peroxide to the wastewater may be performed using a computerized control system. Various aspects of the invention may be implemented as specialized software executing in a general-purpose computer system 100 such as that shown in FIG. 1. The computer system 100 may include a processor 102 connected to one or more memory devices 104, such as a disk drive, solid state memory, or other device for storing data. Memory 104 is typically used for storing programs and data during operation of the computer system 100. Components of computer system 100 may be coupled by an interconnection mechanism 106, which may include one or more busses (e.g., between components that are integrated within a same machine) and/or a network (e.g., between components that reside on separate discrete machines). The interconnection mechanism 106 enables communications (e.g., data, instructions) to be exchanged between system in components of system 100. Computer system 100 also includes one or more input devices 108, for example, a keyboard, mouse, trackball, microphone, touch screen, and one or more output devices 110, for example, a printing device, display screen, and/or speaker. The output devices 110 may also comprise valves or pumps which may be utilized to introduce chemicals, for example enhanced hydrogen peroxide, pH adjustment agents, or catalysts into a wastewater stream. One or more sensors 114 may also provide input to the computer system 100. These sensors may include, for example, chemical concentration sensors such as hydrogen peroxide and/or hydrogen sulfide sensors. ORP sensors, pH sensors, flow meters, liquid level sensors, temperature sensors, or other sensors useful in a wastewater treatment system. These sensors may be located in any portion of a wastewater sewer or treatment system where they would be useful, for example, upstream of an enhanced hydrogen peroxide dosage point, downstream of an enhanced hydrogen peroxide dosage point, or both. In addition, computer system 100 may contain one or more interfaces (not shown) that connect computer system 100 to a communication network in addition or as an alternative to the interconnection mechanism 106.

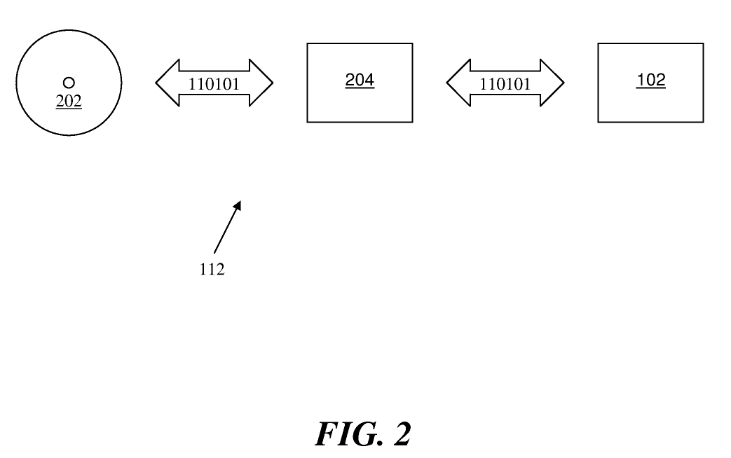

The storage system 112, shown in greater detail in FIG. 2, typically includes a computer readable and writeable nonvolatile recording medium 202 in which signals are stored that define a program to be executed by the processor or information stored on or in the medium 202 to be processed by the program. The medium may, for example, be a disk or flash memory. Typically, in operation, the processor causes data to be read from the nonvolatile recording medium 202 into another memory 204 that allows for faster access to the information by the processor than does the medium 202. This memory 204 is typically a volatile, random access memory such as a dynamic random access memory (DRAM) or static memory (SRAM). It may be located in storage system 112, as shown, or in memory system 104. The processor 102 generally manipulates the data within the integrated circuit memory 104, 204 and then copies the data to the medium 202 after processing is completed. A variety of mechanisms are known for managing data movement between the medium 202 and the integrated circuit memory element 104, 204, and the invention is not limited thereto. The invention is not limited to a particular memory system 104 or storage system 112.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 100 is shown by way of example as one type of computer system upon which various aspects of the invention may be practiced, it should be appreciated that aspects of the invention are not limited to being implemented on the computer system as shown in FIG. 1. Various aspects of the invention may be practiced on one or more computers having a different architecture or components that that shown in FIG. 1.

Computer system 100 may be a general-purpose computer system that is programmable using a high-level computer programming language. Computer system 100 may be also implemented using specially programmed, special purpose hardware. In computer system 100, processor 102 is typically a commercially available processor such as the well-known Pentium™ class processor available from the Intel Corporation. Many other processors are available. Such a processor usually executes an operating system which may be, for example, the Windows 95, Windows 98, Windows NT, Windows 2000 (Windows ME), Windows XP, or Windows Visa operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). In some embodiments one or more components of the computer system 100 may communicate with one or more other components over a wireless network, including, for example, acellular telephone network.

It should be appreciated that the invention is not limited to executing on any particular system or group of systems. Also, it should be appreciated that the invention is not limited to any particular distributed architecture, network, or communication protocol. Various embodiments of the present invention may he programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

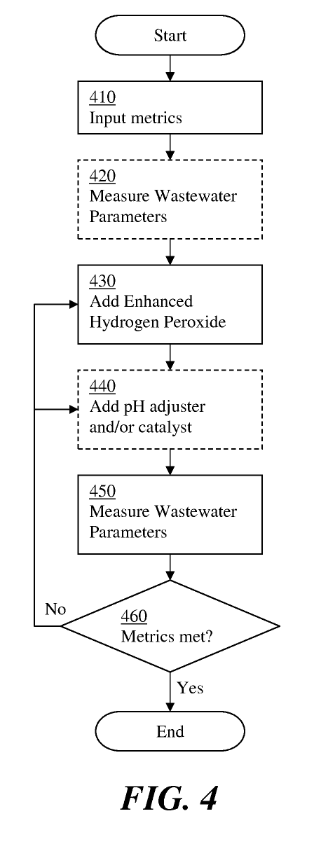

FIG. 4 is a flowchart that depicts a method of operation of a wastewater to treatment system according to one or more illustrative embodiments of the invention. Although the operation of the treatment system is described primarily with respect to a wastewater treatment method or routine that may be executed by a controller (e.g., control system 100 of FIG. 1), it should be appreciated that the invention is not so limited, and many of the steps described below may be implemented manually or batch-wise, for example, by a person, rather than by a controller, as discussed in more detail further below.

At step 410, a user may be requested to input metrics pertaining to the desired quality of a treated wastewater stream. For example, the user may be prompted to enter maximum and/or minimum allowed values for the oxidation-reduction potential of the treated wastewater stream and/or the concentration of dissolved sulfides in and/or gaseous hydrogen sulfide above the treated wastewater stream. Where there are mandated municipal, state, or federal requirements for the treated wastewater stream, or where there are safety and/or environmental requirements or guidelines pertaining to such streams, the user may enter those values or parameters. It should be appreciated that other parameters may be entered at step 410 such as, but not limited to, the maximum and/or minimum pH of the treated wastewater stream and/or the estimated flow rate of the wastewater stream, as the invention is not limited to a particular set of metrics. Moreover, physical parameters of the wastewater stream that may impact the treatment thereof, such as the hydraulic retention time, or the distance between an enhanced hydrogen peroxide feed point and a monitoring point may also be entered. Thereafter, the routine optionally proceeds to step 420.

At step 420, various parameters of the incoming wastewater stream may be measured, as determined by one or more of a plurality of upstream sensors 114. For example, parameters of the incoming wastewater stream that may be measured at step 420 may include the temperature, the oxidation-reduction potential, the pH, and the concentration of dissolved sulfide and/or atmospheric hydrogen sulfide present, or any combination of these parameters. Other parameters that may be measured at step 420 may include, for example, the flow rate of the incoming wastewater stream. The measured parameters of the incoming wastewater stream may be temporarily stored, e.g. in a volatile memory of the controller (e.g., RAM), and/or stored in a more permanent form of memory of the controller (e.g., storage system 202 in FIG. 2), for example, to use as historical data for effecting operation of the controller, as discussed more fully below.

After acquiring parameters of the incoming wastewater stream, the routine proceeds to step 430, wherein the routine determines an amount or rate of addition of enhanced hydrogen peroxide to be added to the incoming wastewater stream. The controller may then output a signal to a pump or valve associated with an enhanced hydrogen peroxide supply commanding the pump or valve to add the determined amount or adjust the rate of addition to the determined rate. The rate or amount of enhanced hydrogen peroxide added at step 430 may be determined, as an independent or dependent function, for example, such as a rate in gallons per day, or as a percentage of the wastewater stream flow. After determining the amount of enhanced hydrogen peroxide to be added to the wastewater stream, the routine can configure a metering valve and/or pump to provide the determined amount of enhanced hydrogen peroxide to the wastewater stream.

At step 440, the routine can determine a rate or an amount of, for example, an optional second and/or third treating species, such as a pH adjuster and/or a catalyst for catalyzing a reaction between dissolved sulfides and hydrogen peroxide, to be added to the incoming wastewater stream, and then adds at that determined rate or the determined amount of the second and/or third treating species thereto. The rate or amount of second and/or third treating species added at step 440 may be determined as an independent or dependent function, for example, as a rate in gallons per day, or as a percentage of the wastewater stream flow. This determination may be based upon either the estimated flow rate, for example, as input at step 410, or the actual flow rate as measured, for example, in step 420.

After either of steps 430 or 440, or both, the wastewater treatment routine may proceed to step 450, wherein various parameters of the treated wastewater stream are measured, as determined by, for example, one or more of downstream sensors 114. For example, parameters of the treated wastewater stream that may be measured at step 450 can include the concentration or level of gaseous hydrogen sulfide present above the treated wastewater stream, the oxidation-reduction potential of the treated wastewater stream, and the concentration or level of dissolved sulfide present in the treated wastewater stream. Other parameters such as pH and the concentration or level of residual hydrogen peroxide present in the treated wastewater stream may also be measured. It should be appreciated that where separate sources of enhanced hydrogen peroxide and second and/or third treating species are used, measurement of the pH of the treated wastewater stream, and/or a concentration of gaseous hydrogen sulfide above the treated wastewater, and/or a concentration of dissolved sulfide in the treated wastewater, and/or a concentration or level of residual hydrogen peroxide present in the wastewater stream may allow the amounts of enhanced hydrogen peroxide and second and/or third treating species to be separately, individually varied and optimized, dependent upon the measured values.

After measuring parameters of the treated wastewater stream, the routine can proceed to step 460, wherein a determination can be made as to whether the desired metrics of the treated wastewater stream have been met, and/or whether the system is optimized. It should be appreciated that the determination as to whether the desired metrics of the treated wastewater stream have been met and/or whether the system is optimized may depend on the location of downstream sensors 114. For example, where downstream sensors 114 are disposed at a control point, this determination may be made by a comparison of the parameters measured at step 450 and the desired metrics for the treated wastewater stream.

Alternatively, where the downstream sensors are disposed downstream of an enhanced hydrogen peroxide dosage point yet at a significant distance upstream of the control point, this determination may be more complex. For example, where the downstream sensors are disposed at a significant distance upstream of the control point, further biological activity may be expected to occur, such that the levels of oxidation-reduction potential of the water stream and/or gaseous hydrogen sulfide and dissolved sulfide at the control point may be greater, or in some cases lesser, than those at the monitoring point wherein the parameters of the treated wastewater stream are measured at step 450. In such case, the parameters measured at step 450 may be adjusted (e.g., upward) to reflect values that would be expected at the control point and then compared to the desired metrics, or alternatively, the desired metrics at the control point may be adjusted (e.g., downward) to reflect values that would be expected at the monitoring point. Although the invention is not so limited, it is preferred that downstream sensors 114 be disposed at the control point, as the determination made at step 460 is thereby made considerably more precise and less complex.

When it is determined at step 460 that the metrics for the treated wastewater stream have been met and the system is optimized, the routine can terminate. Alternatively, when it is determined that the metrics for the treated wastewater stream have not been met, or that the system is not optimized, the routine can be directed to return to step 430 or step 440 wherein the amounts of enhanced hydrogen peroxide, second treating species, and/or third treating species are adjusted as dependent on one or more of the measured parameters measured at, for example, step 450.

The respective amount of enhanced hydrogen peroxide added to the incoming wastewater stream may be adjusted to meet desired metrics for the treated wastewater stream in an economically efficient manner. For example, when it is determined at step 460 that metrics for the levels of oxidation-reduction potential and/or dissolved sulfide and/or gaseous hydrogen sulfide are met, but appreciable levels of residual hydrogen peroxide are present in the treated wastewater stream, the amount of enhanced hydrogen peroxide added may be reduced to further optimize the system. It should be appreciated that the presence of appreciable levels of residual hydrogen peroxide in the treated wastewater stream may indicate that the amount or rate of addition of enhanced hydrogen peroxide added may be reduced while meeting the desired metrics. Of course, as noted previously, whether appreciable levels of residual hydrogen peroxide are present may depend on the position of the sensor used to measure this parameter. For example, where the sensor used to measure levels of residual hydrogen peroxide concentration is disposed at the control point, an average level of residual hydrogen peroxide greater than about 1 or even about 2 m or a peak level of residual hydrogen peroxide greater than approximately 5 mg/L may indicate that the rate and/or amount of enhanced hydrogen peroxide added may be reduced. Dependent upon the pH of the treated wastewater stream, the amount of pH adjustment agent added may also be reduced or increased. Likewise, dependent upon the measured concentration of catalyst species or the measured concentration of a proxy for the activity of the catalyst species, the amount of the catalyst species, or a precursor thereof, may be increased or decreased to accordingly achieve a target, predetermined, or pre-selected value or range. After modifying the respective or collective rate or amounts of enhanced hydrogen peroxide and/or pH adjuster and/or catalyst species added, the routine can be directed to return to steps 450 and 460.

Alternatively, when it is determined that the desired metrics for the levels, such as the oxidation-reduction potential and/or dissolved sulfide and/or gaseous hydrogen sulfide are not met, but little or no residual hydrogen peroxide is measured in the treated water stream and/or the oxidation-reduction potential is below a desirable range, the amount of enhanced hydrogen peroxide added may be increased to further optimize the system. After modifying the rate and/or amount of enhanced hydrogen peroxide added, the routine returns to steps 450 and 460.

Where metrics for dissolved sulfide are met, but metrics for gaseous hydrogen sulfide are not, and appreciable levels of residual hydrogen peroxide are measured in the treated water stream (e.g., an average level above about 1 or about 2 mg/L, or a peak level above approximately 5 mg/L, as measured at the control point), an amount of alkaline pH adjuster species added may be increased, and/or an amount of acidic pH adjuster species may be reduced to shift the H₂S/HS⁻ equilibrium point to favor HS⁻, thereby also further increasing the reduction of the residual hydrogen peroxide, and further optimizing the system. Alternatively, where metrics for gaseous hydrogen sulfide are met, and those for dissolved sulfide are not, and appreciable levels of residual hydrogen peroxide are measured in the treated wastewater stream, an amount of alkaline pH adjuster species added may be decreased and/or an amount of acidic pH adjuster species added may be increased to shift the H₂S/HS⁻ equilibrium point to favor gaseous hydrogen sulfide, thereby reducing the level of dissolved sulfide. After modifying the rate and/or amount of pH adjuster added to either increase or decrease the amount of alkaline and/or acidic species added to the wastewater stream, the routine can returns to steps 450 and 460.

Adjustment of the individual or collective amounts of the added enhanced hydrogen peroxide may be performed in steps or increments or may be performed utilizing any suitable control algorithm such as but not limited to those employing proportional, integral, and/or derivative based techniques. Other techniques that may be utilized include, for example, on/off control and time-based or variable on/off control. Further, the control loops or algorithms may be configured to utilize nesting techniques. For example, adjustment of the added amounts may be dependent on, as a primary parameter, the measured oxidation-reduction potential and on, as a secondary parameter, the measured pH and/or the measured temperature of the wastewater stream. In other cases, several ORP values can be utilized in such techniques or in separately operating systems.

The embodiments utilizing feedback control can adjust the rate and/or amount of enhanced hydrogen peroxide added to the incoming wastewater stream, based upon measured parameters of the treated wastewater stream. Accordingly, even if the initial rates or amounts of enhanced hydrogen peroxide added to the incoming wastewater stream are not optimal, the system can readily adjust to optimal values over time. Further, due to this type of feedback control, the system can respond to changes in the incoming wastewater stream. A feedforward based system could alternatively be utilized in the accordance with the techniques of the invention.

Although several of the steps or acts described herein have been described in relation to being implemented on a computer system or stored on a computer-readable medium, it should be appreciated that the invention is not so limited. Indeed, any one or more of the steps or acts may be implemented by, for example, an operator, without use of an automated system or computer. For example, the measuring of the parameters of the incoming and treated wastewater streams may be performed by a human operator, and based upon those parameters, that operator, or another operator may manually adjust amounts of the enhanced hydrogen peroxide added to the incoming wastewater stream. Moreover, the determination made at step 460 may be performed by a person, perhaps with the aid of a simple flow chart. Accordingly, although the wastewater treatment routine was described primarily with respect to being implemented on a computer, it should be appreciated that the invention is not so limited.

It should be appreciated that numerous alterations, modifications, and improvements may be made to the illustrated treatment method. For example, as discussed above, the parameters of an incoming wastewater stream, such as, but not limited to, the flow rate of an incoming wastewater stream, the oxidation-reduction potential, temperature, and pH of the incoming wastewater stream, as well as the levels of gaseous hydrogen sulfide present above and dissolved sulfide present in the incoming wastewater stream frequently vary in a cyclical manner (e.g., by day of the week, by time of day, etc.). Such historical data reflecting parameters of the incoming wastewater stream may be used by the controller to predict parameters of the incoming wastewater stream at a future time, and adjust the rate and/or amount of enhanced hydrogen peroxide and/or the rate and/or amount of second and/or third treating species added to the incoming wastewater stream in dependence thereon. For example, if past historical data indicates that the oxidation-reduction potential, the pH, and/or the flow of the incoming wastewater stream varies in acyclic manner, or if the levels of gaseous hydrogen sulfide or dissolved sulfide vary in acyclic manner, the rate and/or amount of the enhanced hydrogen peroxide may be varied in anticipation thereof.

Further, it should be appreciated that the operation of the controller may vary depending upon the placement of the upstream sensors 114, and/or the downstream sensors 114 relative to the control point. For example, where the downstream sensors are disposed at the control point and it is determined that the levels of gaseous hydrogen sulfide and/or dissolved sulfide exceed the desired metrics, it may be too late to change the feed rate and/or amount of enhanced hydrogen peroxide. Where this is the case, the controller may be modified to respond to changes in the measured parameters of the incoming wastewater stream.

Although the embodiments exemplarily shown or presented herein have been described as using a plurality of upstream and downstream sensors, it should be appreciated that the invention is not so limited. For example, rather than requiring any electronic or electro-mechanical sensors, the measurement of levels of gaseous hydrogen sulfide and dissolved sulfide species present in the incoming and/or treated wastewater streams could alternatively be based upon the olfactory senses of an operator or manually gathered data. As known to those skilled in the art, humans are typically capable of detecting levels of gaseous hydrogen sulfide in excess of four parts per billion, thus a human operator could be instructed to adjust the rate and/or amount of enhanced hydrogen peroxide added to the incoming wastewater stream depending upon whether gaseous hydrogen sulfide odor was noticeable or not.

### Prophetic Examples

### Prophetic Example I

The following prophetic example describes a hypothetical bench test with the objectives of demonstrating that Peroxide XL will persist in wastewater at a particular dosage for a longer period than a standard hydrogen peroxide and therefore will remain active for sulfide removal in wastewater for a longer period than standard hydrogen peroxide to react with sulfides formed after an initial dosing.

### Testing Procedure:

A sulfide solution is prepared from sodium sulfide and distilled water by measuring and dissolving 7.49 grams Na₂S.9H₂O in 100 mL of distilled water, resulting in a 100 mL sample of 10,000 mg/L S²⁻. A standard hydrogen peroxide solution is prepared by diluting 1.68 mL of 50% standard hydrogen peroxide to 100 mL with distilled water, resulting in 100 mL of 10,000 mg/L standard hydrogen peroxide. A standard hydrogen peroxide solution is prepared by diluting 1.68 mL of 50% Peroxide XL to 100 mL with distilled water, resulting in 100 mL of 10,000 mg/L Peroxide XL

Sample bottles are prepared by drilling one hole to snugly fit a GasTec 211 tube and another to snugly fit an ExTech pH probe and a YSI ORP electrode in each of 15 one liter bottles. The bottles are numbered 1 through 15. A Teflon™ resin coated magnetic stir bar is placed in each bottle.

Several gallons of untreated raw sewage are obtained from Lakewood Ranch Repump lift station in Manatee County, FL.

Each of the 15 one liter bottles is filled with the raw sewage and capped with as little air space as possible, plugging the holes to prevent contact with the atmosphere. All bottles are kept in the dark except when measuring parameters.

The concentration of dissolved sulfide, as well as the pH, temperature, and ORP of each sample measured and recorded.

Bottles 1-3 are controls and have no peroxide added to them. Bottles 4-6 and 10-12 are treated with standard hydrogen peroxide and bottles 7-9 and 13-15 are treated with Peroxide XL, all tests being performed in triplicate.

The average sulfide concentration in bottles 1-15 is calculated, then multiplied by four to determine the dosing of standard hydrogen peroxide for bottles 4-6 and 10-12, and hydrogen peroxide XL for bottles 7-9 and 13-15.

An initial dose of standard hydrogen peroxide is added to bottles 4-6 and 10-12 by adding 0.10 mL of the 10,000 mg/L standard hydrogen peroxide for each mg/L dose to the bottles. An initial dose of Peroxide XL is added to bottles 7-9 and 13-15 by adding 0.10 mL of the 10,000 mg/L Peroxide XL solution for each mg/L dose to the bottles.

Hydrogen peroxide residual, dissolved sulfide concentration, pH, temperature and ORP is measured and recorded for each bottle. These measurements are repeated until there is no hydrogen peroxide residual in bottles 3-6 and 10-12.

To replicate a formation of additional sulfide in the wastewater after the initial hydrogen peroxide dose, 1 mL of the 10,000 mg/L sulfide is added to bottles 10-15.

Hydrogen peroxide residual, dissolved sulfide, pH, temperature and ORP measurements are continued, until there is no hydrogen peroxide residual in any bottle.

### Prophetic Results:

The following results would be expected to be obtained in the experimental setup and procedure described above.

| | Time | | | | | | | | | |
|---|---|---|---|---|---|---|---|---|---|---|
| | O hours | | 1 hour | | 2 hours | | 3 hours | | 4 hours | |
| Bottle | [S²⁻] | [H₂O₂] | [S²⁻] | [H₂O₂] | [S²⁻] | [H₂O₂] | [S²⁻] | [H₂O₂] | [S²⁻] | [H₂O₂] |
| 1-3 | 10 | 0 | 10 | 0 | 11 | 0 | 11 | 0 | 11 | 0 |
| 4-6 | 10 | 0 | 5 | 20 | 0 | 0 | 0 | 0 | 0 | 0 |
| 7-9 | 10 | 0 | 5 | 30 | 0 | 20 | 0 | 10 | 0 | 5 |
| 10-12 | 10 | 0 | 5 | 20 | 0 | 0 | 8 | 0 | 7 | 0 |
| 13-15 | 10 | 0 | 5 | 30 | 0 | 20 | 3 | 5 | 0 | 0 |

As illustrated in the above table, with the above described experimental setup and procedure, it would be expected to observe a small amount (5-10 ppm) of residual Peroxide XL in the bottles dosed with Peroxide XL (bottles 7-9 and 13-15) after three hours. In contrast, no residual peroxide would be observed after two hours in the bottles dosed with standard peroxide (bottles 4-6 and 10-12.) Further, for the bottles to which additional dissolved sulfide was added (bottles 10-15), dissolved sulfide concentrations are lower over time for the bottles dosed with the Peroxide XL (bottles 13-15) than those dosed with the standard peroxide (bottles 10-12).

These prophetic results illustrate that Peroxide XL is expected to be more effective than standard hydrogen peroxide at providing a residual level of hydrogen peroxide in wastewater over time, as well as for destroying additional sulfide added to the wastewater hours after the hydrogen peroxide dose.

### Prophetic Example II

### Background:

A city has used 50% concentrated standard hydrogen peroxide to control hydrogen sulfide in its wastewater collection system and treatment plant for many years. Peroxide is added at a master pump facility and booster pump facility (BPF 308). Both of these facilities include lift stations (LSs) to raise the level of wastewater in the system to provide for gravitationally induced flow downstream through the system. The system employs the use of surge tanks at each of these lift stations to prevent high flows from entering the wastewater treatment plant. In addition, 50% standard hydrogen peroxide is injected into a 14 inch force main at an intermediate lift station.

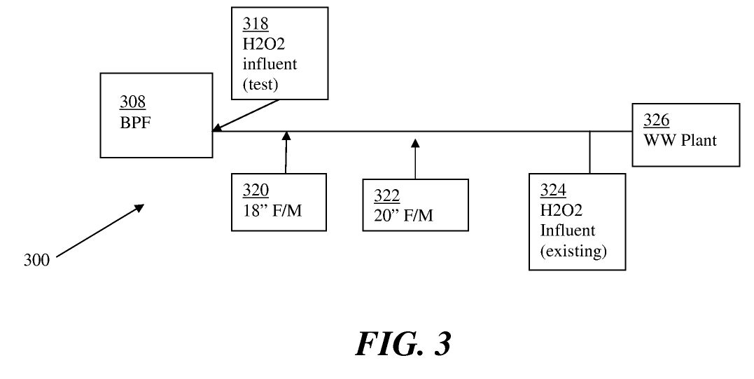

In this example, a hypothetical test is performed injecting enhanced hydrogen peroxide at the booster pump facility discharge and monitoring residual hydrogen peroxide and sulfate concentration in wastewater at the wastewater treatment plant headworks. A diagram of the pumping system in which this prophetic example is performed is indicated generally at 300 in FIG. 3.

### Testing Conditions:

At the BPF 308 discharge there is an unused hydrogen peroxide injection point 318 upstream of 18 inch and 20 inch force mains 320, 322. It is approximately 30,000 feet from the hydrogen peroxide injection point 318 to the headworks of the wastewater treatment plant 326. There is a hydrogen peroxide injection point proximate the wastewater treatment plant 326, near the berm right of way on the 20 inch force main 322. Under normal operating conditions, 40 gallons per day of standard hydrogen peroxide is added to wastewater at the injection point on the 20 inch force main. Hydraulic retention time to the wastewater treatment plant 326 headworks from the discharge of the BPF 308 is 5-6 hours. The average daily flow at the BPF 302 is 2.45 million gallons per day (MGD).

### Testing Procedure:

A first part of the testing involved conducting background testing prior to start-up of the Peroxide XL to establish background sulfides and residual peroxide existing at a tap at the inlet to the wastewater treatment plant. Existing hydrogen peroxide equipment was utilized to feed Peroxide XL at the BPF 302 at a rate of 100 -150 gpd. Standard hydrogen peroxide dosing at the wastewater treatment plant influent injection point was ceased. Aqueous sampling at the inlet to the wastewater treatment plant was conducted to determine if equal or better results with regard to sulfate destruction could be achieved with the experimental setup utilizing Peroxide XL versus the existing process utilizing standard hydrogen peroxide.

### Prophetic Results:

The following results are expected to have been obtained in the experimental setup and procedure described above.

Data Obtained at Wastewater Treatment Plant Inlet

| | Standard | Peroxide | Total | Peroxide XL | | Temp | |
|---|---|---|---|---|---|---|---|
| | Peroxide | XL Dose | Sulfide | Residual | pH | (degrees | |
| Day | Dose GPD* | GPD* | mg/L Range | ppm Range | Range | F.) Range | Comments |
| 1 | 100 | 0 | 1-4 | 0 | 7.1-7.3 | 82-85 | Background |
| 2 | 0 | 100 | 0.1-0.6 | 1.5 | 7.0-7.2 | 84-85 | 1^{st} Run |
| 3 | 0 | 150 | 0.0-0.3 | 5.0 | 6.9-7.0 | 82-87 | 2^{nd} Run |
| 4 | 0 | 100 | 0.1-0.6 | 1.5 | 7.1 | 85 | 3^{rd} Run |

*Gallons per Day

As illustrated in the above table, with the above described experimental setup and procedure, it would be expected to observe a small amount (1.5-5 ppm) of residual hydrogen peroxide at the inlet to the wastewater treatment plant with Peroxide XL injected at the BPF discharge at levels as low as 100 gallons per day. This residual peroxide would be sufficient to keep the total sulfide levels at the wastewater treatment plant at or below that observed with the process of record wherein normal hydrogen peroxide was dosed at the wastewater treatment plant influent injection point.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to he within the spirit and scope of the invention. Accordingly, the foregoing description and drawings are by way of example only.

What is claimed is:

1. A method of treating wastewater comprising:
measuring a concentration of a reduced sulfur compound in the wastewater, the reduced sulfur compound comprising a dissolved sulfide;
contacting the wastewater with an amount of an enhanced hydrogen peroxide solution producing a molecular ratio of not more than four to one of hydrogen peroxide to the dissolved sulfide in the wastewater; and
maintaining the wastewater under conditions sufficient to lessen a concentration of the dissolved sulfide in the wastewater to less than one milligram per liter after an enhanced residence time of the hydrogen peroxide in the wastewater.

2. The method of claim 1, further comprising flowing the wastewater through a conduit.

3. The method of claim 2, further comprising providing a control system configured to measure at least one of a concentration of the reduced sulfur compound dissolved in the wastewater and a concentration of a gaseous form of the reduced sulfur compound present in air above the wastewater, and to adjust a rate of addition of the enhanced hydrogen peroxide solution to the wastewater based at least in part on the measured concentration.

4. The method of claim 3, wherein the concentration of the at least one of the reduced sulfur compound dissolved in the wastewater and the gaseous form of the reduced sulfur compound present in air above the wastewater is measured upstream of a point in the conduit at which the wastewater is contacted with the enhanced hydrogen peroxide.

5. The method of claim 3, wherein the concentration of the at least one of the reduced sulfur compound dissolved in the wastewater and the gaseous form of the reduced sulfur compound present in air above the wastewater is measured downstream of a point in the conduit at which the wastewater is contacted with the enhanced hydrogen peroxide.

6. The method of claim 5, wherein the concentration of the at least one of the reduced sulfur compound dissolved in the wastewater and the gaseous form of the reduced sulfur compound present in air above the wastewater is measured at a point in the conduit to which the wastewater has flowed after an enhanced residence time greater than about four hours.

7. The method of claim 3, wherein the control system is configured to measure a pH of the wastewater and to add a quantity of pH adjustment agent to the wastewater in response to the measured pH being outside a defined range.

8. The method of claim 3, wherein the control system is configured to add a quantity of catalyst to the wastewater in response to the measured concentration being outside a defined range.

9. The method of claim 1, wherein the reduced sulfur compound is at least one of hydrogen sulfide, carbon disulfide, dimethyl sulfide, dimethyl disulfide, dimethyl trisulfide, a methyl mercaptan, an ethyl mercaptan, an allyl mercaptan, a propyl mercaptan, a crotyl mercaptan, a benzyl mercaptan, thiophenol, sulfur dioxide, and carbon oxysulfide.

10. A method of treating wastewater comprising:
measuring a concentration of a reduced sulfur compound in the wastewater;
contacting the wastewater with an amount of an enhanced hydrogen peroxide solution producing a molecular ratio of not more than four to one of hydrogen peroxide to the dissolved sulfide in the wastewater; and
maintaining the wastewater under conditions sufficient to provide at least 1 ppm residual active hydrogen peroxide in the wastewater after an enhanced residence time of the hydrogen peroxide in the wastewater.

11. The method of claim 10, further comprising providing a control system configured to measure a concentration of hydrogen peroxide in the wastewater, and to adjust a rate of addition of the enhanced hydrogen peroxide solution to the wastewater based on the measured concentration.

12. The method of claim 11, wherein the concentration of the hydrogen peroxide in the wastewater is measured at a point in a conduit to which the wastewater has flowed after an enhanced residence time greater than about four hours.

13. The method of claim 12, wherein the control system is further configured to measure a concentration of gaseous hydrogen sulfide and to adjust a quantity of pH adjustment agent added to the wastewater in response to the measured concentration of hydrogen peroxide and the measured concentration of gaseous hydrogen sulfide.

14. The method of claim 11, wherein the control system is configured to add a quantity of catalyst to the wastewater in response to the measured concentration being outside a defined range.

15. A method of facilitating the removal of odorous compounds from wastewater comprising:
providing a quantity of an enhanced hydrogen peroxide solution comprising about five weight percent of a nitrate based stabilization agent, between about 40 weight percent and about 51 weight percent hydrogen peroxide, and between about 44 weight percent and about 55 weight percent water; and
providing instructions for treating the wastewater with the enhanced hydrogen peroxide solution to result in a desired concentration of a dissolved sulfide in the wastewater after a desired enhanced residence time of the hydrogen peroxide solution in the wastewater.

16. The method of claim 15, further comprising providing instructions for modifying a rate of addition of the enhanced hydrogen peroxide to the wastewater based on a measurement of a dissolved sulfide in the wastewater.

17. The method of claim 15, further comprising providing instructions for modifying a rate of addition of the enhanced hydrogen peroxide to the wastewater based on a measurement of a gaseous sulfide compound produced from the wastewater.

18. The method of claim 15, further comprising providing instructions for modifying a rate of addition of the enhanced hydrogen peroxide to the wastewater based on a measurement of a residual amount of hydrogen peroxide remaining in the wastewater at a defined time after the treatment of the wastewater with the enhanced hydrogen peroxide.

19. The method of claim 15, further comprising providing instructions for modifying a rate of addition of a pH adjustment agent to the wastewater based on a comparison of a concentration of dissolved sulfide in the wastewater with a concentration of a gaseous sulfide compound present above the wastewater at a defined time after the treatment of the wastewater with the enhanced hydrogen peroxide.

20. A system for treating wastewater flowing through a conduit comprising:
a source of a hydrogen peroxide solution comprising about five weight percent of a nitrate based stabilization agent, between about 40 weight percent and about 51 weight percent hydrogen peroxide, and between about 44 weight percent and about 55 weight percent water;
a dosing system configured to add the hydrogen peroxide solution into the conduit;
a first sensor configured to measure a concentration of at least one of sulfide dissolved in the wastewater and gaseous hydrogen sulfide above a surface of the wastewater in the conduit upstream of the dosing system: and
a controller configured to receive a signal from the first sensor and adjust a rate of addition of the hydrogen peroxide solution into the conduit based at least in part on the signal from the first sensor.

21. The system of claim 20, further comprising a second sensor configured to measure a concentration of at least one of sulfide dissolved in the wastewater and gaseous hydrogen sulfide above a surface of the wastewater in the conduit downstream of the dosing system and to provide the controller with a signal indicative of the measured concentration, wherein the controller is further configured to adjust a rate of addition of the hydrogen peroxide solution into the conduit based at least in part on the signal from the second sensor.

22. The system of claim 20, further comprising a second sensor configured to measure a concentration of hydrogen peroxide in the wastewater downstream of the dosing system and to provide the controller with a signal indicative of the measured concentration, wherein the controller is further configured to adjust a rate of addition of the hydrogen peroxide solution into the conduit based at least in part on the signal from the second sensor.
